(19) United States
(12) Patent Application Publication
(10) Pub. No.: US 2015/0154473 A1
(43) Pub. Date: Jun. 4, 2015

(54) INFORMATION PROCESSING DEVICE, CASH PROCESSING TERMINAL, AND INFORMATION PROCESSING SYSTEM

(71) Applicant: Oki Electric Industry Co., Ltd., Tokyo (JP)

(72) Inventors: Masaru Shimakata, Tokyo (JP); Akihiro Sasaki, Tokyo (JP)

(73) Assignee: Oki Electric Industry Co., Ltd., Tokyo (JP)

(21) Appl. No.: 14/406,100

(22) PCT Filed: May 14, 2013
(86) PCT No.: PCT/JP2013/063447

§ 371 Date: Dec. 5, 2014

(30) Foreign Application Priority Data
Jul. 10, 2012 (JP) 2012-154393

(51) Int. Cl. G06K 9/62; G06K 9/00

(52) U.S. Cl. CPC G06K 9/6217; G06K 9/00442

(57) ABSTRACT

There is provided an information processing device disposed between a cash processing terminal group in a local network and an outside network existing outside the local network, the information processing device including: an information acquisition unit that acquires, in the local network, a serial number obtained as a result of a currency bill being read by a cash processing terminal configuring the cash processing terminal group; a storage control unit that stores the serial number in a storage unit; and a determination unit which, in a case in which a serial number obtained as a result of a currency bill being read by any cash processing terminal configuring the cash processing terminal group has been acquired, determines whether or not that serial number matches the serial number stored in the storage unit.

### TECHNICAL FIELD

The present invention relates to an information processing device, a cash processing terminal, and an information processing system.

### BACKGROUND ART

Cash processing terminals that handle currency bills are typically installed in financial institutions such as banks Examples of cash processing terminals include an automatic teller machine (ATM), a teller cash recycler (TCR), a receipts-and-disbursements cash counting machine, and a currency bill sorter. These cash processing terminals are connected to a local network (e.g., see Japanese Patent Application Laid-open No. (JP-A) 2010-049373). Furthermore, an ATM control unit, a teller terminal, a receipts-and-disbursements terminal, and a currency bill sorter terminal, which correspond to higher-level terminals of these cash processing terminals, are connected to the local network.

The currency bills have consecutive numbers (hereinafter called “serial numbers”) printed on them according to each type of currency bill, and the cash processing terminals have the function of reading the serial numbers printed on the currency bills. The serial numbers read by the ATM can be accumulated in the ATM control unit. Likewise, the serial numbers read by the teller cash recycler can be accumulated in the teller terminal, the serial numbers read by the receipts-and-disbursements cash counting machine can be accumulated in the receipts-and-disbursements terminal, and the serial numbers read by the currency bill sorter can be accumulated in the currency bill sorter terminal.

### SUMMARY OF INVENTION

### Technical Problem

However, in this system, the serial numbers read by the cash processing terminals are merely accumulated in the cash processing terminals themselves or in their higher-level terminals (in the above example, the ATM control unit, the teller terminal, the receipts-and-disbursements terminal, and the currency bill sorter terminal). For that reason, the serial numbers read by the cash processing terminals are not centrally managed and cannot be easily searched and analyzed.

Furthermore, in this system, supposing central management of the serial numbers, it would be necessary for the cash processing terminals to send the serial numbers to an accounting system via a backbone network existing outside the local network and for the accounting system to centrally manage the serial numbers. However, the accounting system is a place where a bank strictly manages data, so from the standpoint of security and communication volume, the accounting system cannot be easily accessed to search and analyze the serial numbers.

Furthermore, predetermined serial numbers can be registered in the cash processing terminals using a maintenance menu or the like. For example, in a case where a counterfeit bill has been discovered in the market, the serial number (more specifically, all or some of the numbers in the serial number) of that counterfeit bill can be registered in the cash processing terminals. After the serial number of the counterfeit bill has been registered in the cash processing terminals, the cash processing terminal that has detected the currency bill bearing that serial number can stop the transaction by forcibly rejecting that currency bill or isolating that currency bill in a designated storage vault.

However, in order to register the serial number of a counterfeit bill, it is necessary for an operator (e.g., a bank employee or a maintenance worker) to manually enter the serial number into each cash processing terminal, so the working time of the operator cannot be reduced, and it has also been easy for entry errors when entering the serial number of a counterfeit bill to occur.

Therefore, the present invention provides a technology with which the serial numbers read by the cash processing terminals can be easily searched and analyzed and which reduces the time and effort of registering the serial numbers of counterfeit bills in the cash processing terminals.

### Solution to Problem

According to an aspect of the present invention, there is provided an information processing device disposed between a cash processing terminal group in a local network and an outside network existing outside the local network, the information processing device including: an information acquisition unit that acquires, in the local network, a serial number obtained as a result of a currency bill being read by a cash processing terminal configuring the cash processing terminal group; a storage control unit that stores the serial number in a storage unit; and a determination unit which, in a case in which a serial number obtained as a result of a currency bill being read by any cash processing terminal configuring the cash processing terminal group has been acquired, determines whether or not that serial number matches the serial number stored in the storage unit.

The information processing device may further include a serial number notification unit which, in a case in which it has been determined by the determination unit that the serial numbers match, gives notification of the serial number to any cash processing terminal configuring the cash processing terminal group or to a cash processing terminal in a local network that is different from the local network.

The serial number notification unit may give notification to a cash processing terminal selected from among any cash processing terminal configuring the cash processing terminal group and a cash processing terminal in a local network that is different from the local network.

Furthermore, according to an aspect of the present invention, there is provided a cash processing terminal configuring a cash processing terminal group in a local network, the cash processing terminal including: a serial number acquisition unit which, in a case in which it has been determined that a serial number of a currency bill is a duplicate, acquires that serial number from an information processing device disposed between the cash processing terminal and an outside network existing outside the local network; and a movement control unit that performs control so that the currency bill bearing the serial number acquired by the serial number acquisition unit is moved to a predetermined location.

The predetermined location may be either a reject vault for currency bills or a designated storage vault for currency bills.

Furthermore, according to an aspect of the present invention, there is provided an information processing system including a cash processing terminal configuring a cash processing terminal group in a local network and an information processing device disposed between the cash processing terminal and an outside network existing outside the local network, wherein the cash processing terminal includes an information notification unit that gives notification of a serial number obtained by reading a currency bill, and the information processing device includes: an information acquisition unit that acquires, in the local network, the serial number of which notification has been given by the cash processing terminal; a storage control unit that stores the serial number in a storage unit; and a determination unit which, in a case in which a serial number obtained as a result of a currency bill being read by any cash processing terminal configuring the cash processing terminal group has been acquired, determines whether or not that serial number matches the serial number stored in the storage unit.

The information processing device may further include a serial number notification unit which, in a case in which it has been determined by the determination unit that the serial numbers match, gives notification of the serial number to any cash processing terminal configuring the cash processing terminal group or a cash processing terminal in a local network that is different from the local network.

The serial number notification unit may give notification to a cash processing terminal selected from among any cash processing terminal configuring the cash processing terminal group and a cash processing terminal in a local network that is different from the local network.

### Advantageous Effects of Invention

As described above, according to the present invention, the serial numbers read by the cash processing terminals can be easily searched and analyzed. Furthermore, the time and effort of registering the serial numbers of counterfeit bills in the cash processing terminals can be reduced.

### BRIEF DESCRIPTION OF DRAWINGS

FIG. 1 is a drawing showing the configuration of a typical information processing system;

FIG. 2 is a drawing showing the configuration of an information processing system pertaining to an embodiment of the present invention;

FIG. 3 is a drawing showing an example functional configuration of a cash processing terminal pertaining to the embodiment of the present invention;

FIG. 4 is a drawing showing an example functional configuration of an information processing device pertaining to the embodiment of the present invention;

FIG. 5 is a drawing showing an example configuration of accumulation data accumulated in the information processing device;

FIG. 6 is a drawing showing an example configuration of accumulation data accumulated in the information processing device;

FIG. 7 is a drawing showing an example configuration of accumulation data accumulated in the information processing device;

FIG. 8 is a drawing showing an example operation of the information processing system;

FIG. 9 is a drawing showing an example of a flow of operations of the information processing device; and

FIG. 10 is a drawing showing another example of a flow of operations of the information processing device.

### DESCRIPTION OF EMBODIMENT

A preferred embodiment of the present invention will be described in detail below with reference to the attached drawings.

In this specification and the drawings, redundant description of constituent elements having substantially the same functional configurations will be omitted by assigning the same reference signs to those constituent elements.

Furthermore, in this specification and the drawings, there are also cases where plural constituent elements having substantially the same functional configurations are differentiated from one another by assigning different alphabetical letters to the ends of the same reference signs. However, just the same reference signs are assigned in cases where it is not particularly necessary to differentiate between each of those plural constituent elements having substantially the same functional configurations.

Description of Typical Technology

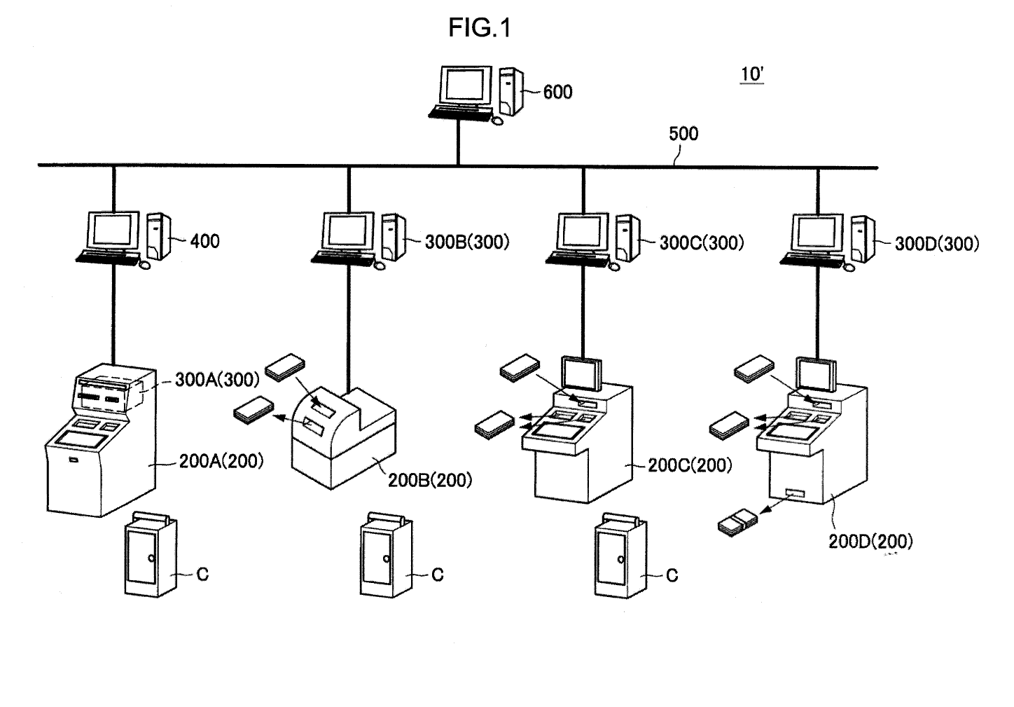

First, the configuration of a typical information processing system 10′ will be described. FIG. 1 is a drawing showing the configuration of the typical information processing system 10′. As shown in FIG. 1, the typical information processing system 10′ is equipped with cash processing terminals 200 that handle currency bills, higher-level terminals 300 that correspond to terminals at a higher level than the cash processing terminals 200, an ATM monitoring device 400, and an accounting system 600.

As was described above, the cash processing terminals 200 and the higher-level terminals 300 exist in a local network (that is, the cash processing terminals 200 and the higher-level terminals 300 are connected to a local network). The local network is constructed by a local area network (LAN), for example. A backbone network 500 is an outside network existing outside the local network and is constructed by a wide area network (WAN), for example. The accounting system 600 is connected to the backbone network 500.

The cash processing terminals 200 are installed in a financial institution such as a bank. Examples of the cash processing terminals 200 include an ATM 200A, a teller cash recycler 200B, a receipts-and-disbursements cash counting machine 200C, and a currency bill sorter 200D. Furthermore, examples of the higher-level terminals 300 include an ATM control unit 300A, a teller terminal 300B, a receipts-and-disbursements terminal 300C, and a currency bill sorter terminal 300D.

The ATM 200A is a terminal for allowing customers to deposit and/or withdraw currency bills and is equipped with a cassette C for storing currency bills and operated. Furthermore, the ATM 200A has the ATM control unit 300A inside and is connected to the ATM monitoring device 400. In the example shown in FIG. 1, one ATM 200A is connected to the ATM monitoring device 400, but plural ATMs 200A may also be connected to the ATM monitoring device 400. The ATM 200A is installed in a branch of the financial institution. The ATM monitoring device 400 is typically connected to the accounting system 600 via the backbone network 500.

The teller cash recycler 200B is a terminal for allowing a bank employee to deposit currency bills received from customers and withdraw currency bills in accordance with customer requests on the basis of operations performed by the bank employee on the teller terminal 300B. The teller cash recycler 200B is installed at the service counter of the financial institution, for example. Like the ATM 200A, the teller cash recycler 200B is also equipped with a cassette C for storing currency bills and operated. The teller terminal 300B is typically connected to the accounting system 600 via the backbone network 500.

The receipts-and-disbursements cash counting machine 200C has the function of counting money collected from the ATM 200A and/or the teller cash recycler 200B to calculate the balance of cash on hand on the basis of operations performed by a bank employee on the receipts-and-disbursements terminal 300C. The receipts-and-disbursements cash counting machine 200C is installed behind the service counter or in a back room of the bank, for example. Like the ATM 200A, the receipts-and-disbursements cash counting machine 200C is also equipped with a cassette C for storing currency bills and operated. The receipts-and-disbursements terminal 300C is typically connected to the accounting system 600 via the backbone network 500.

The currency bill sorter 200D has the function of counting money collected from the ATM 200A and/or the teller cash recycler 200B, sorting cash, and strapping every predetermined number (e.g., 100 bills) of currency bills on the basis of operations performed by a bank employee on the currency bill sorter terminal 300D. The currency bill sorter 200D prints strap numbers on the bill bundles strapped every predetermined number and outputs the bill bundles. The currency bill sorter 200D can store the printed strap numbers in units of date, hour, minute, and second. The currency bill sorter 200D is installed behind the service counter or in a back room of the bank, for example. The currency bill sorter 200D does not have a cassette C for storing currency bills. The currency bill sorter terminal 300D is typically connected to the accounting system 600.

The cassettes C used in the ATM 200A, the teller cash recycler 200B, and the receipts-and-disbursements cash counting machine 200C are typically compatible. Furthermore, the cassettes C each have a unique ID (hereinafter also called a “cassette ID”), and the cassette IDs are stored by memories existing inside the cassettes C. The cassette IDs are read by the cash processing terminals 200 when the cassettes C are loaded into the cash processing terminals 200.

The cash processing terminals 200 each have a unique ID (hereinafter also called a “device ID”), and the device IDs are stored by memories existing inside the cash processing terminals 200. As was described above, the currency bills have serial numbers printed on them, and the cash processing terminals 200 have the function of reading the serial numbers printed on the currency bills. The serial numbers read by the ATM 200A can be accumulated in the ATM control unit 300A. Likewise, the serial numbers read by the teller cash recycler 200B can be accumulated in the teller terminal 300B, the serial numbers read by the receipts-and-disbursements cash counting machine 200C can be accumulated in the receipts-and-disbursements terminal 300C, and the serial numbers read by the currency bill sorter 200D can be accumulated in the currency bill sorter terminal 300D.

However, in the information processing system 10′, the serial numbers read by the cash processing terminals 200 are merely accumulated in the cash processing terminals 200 or in their higher-level terminals (in the above example, the ATM control unit 300A, the teller terminal 300B, the receipts-and-disbursements terminal 300C, and the currency bill sorter terminal 300D). For that reason, the serial numbers read by the cash processing terminals 200 are not centrally managed and cannot be easily searched and analyzed.

Furthermore, in the information processing system 10′, supposing central management of the serial numbers, it would be necessary for the cash processing terminals 200 to send the serial numbers to the accounting system 600 via the backbone network 500 existing outside the local network and for the accounting system 600 to centrally manage the serial numbers. However, the accounting system 600 is a place where the bank strictly manages data, so from the standpoint of security and/or communication volume, the accounting system 600 cannot be easily accessed to search and/or analyze the serial numbers.

Therefore, in the embodiment of the present invention, there is proposed a technology with which the serial numbers read by the cash processing terminals 200 can be easily searched and analyzed.

Description of Embodiment

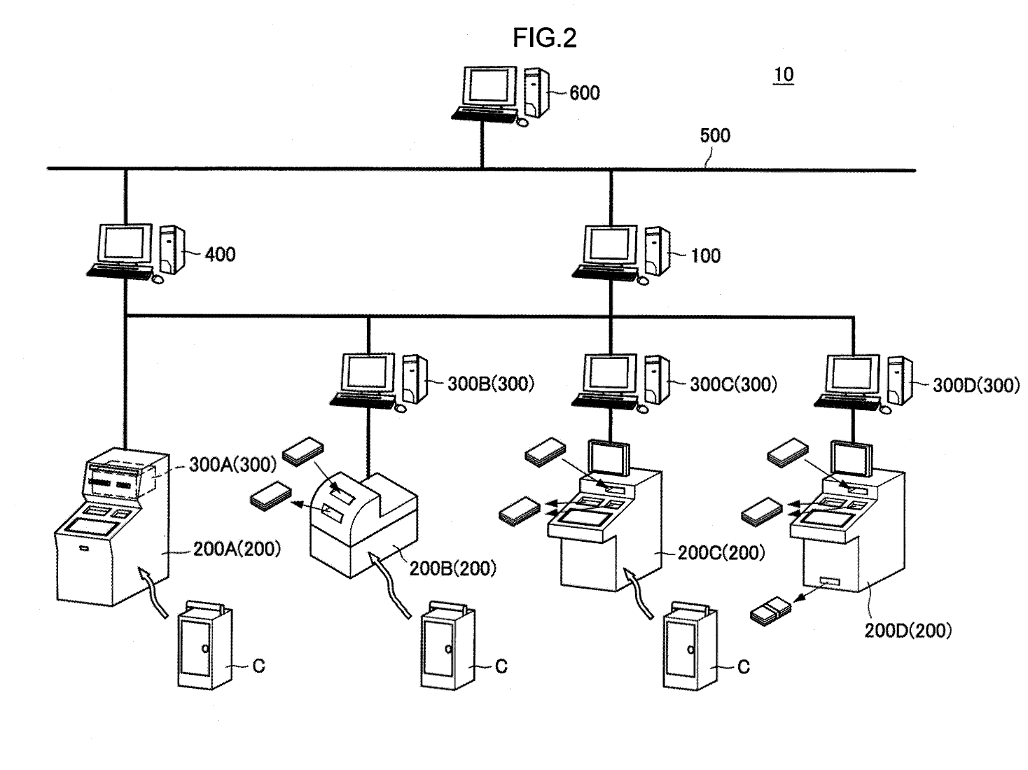

Next, the configuration of an information processing system 10 pertaining to the embodiment of the present invention will be described. FIG. 2 is a drawing showing the configuration of the information processing system 10 pertaining to the embodiment of the present invention. As shown in FIG. 2, the information processing system 10 mainly differs from the typical information processing system 10′ in that the information processing system 10 is equipped with an information processing device 100. In particular, the information processing device 100 is disposed between one or plural cash processing terminals 200 (hereinafter called a “cash processing terminal group”) in the local network and the backbone network 500.

The information processing device 100 acquires, in the local network, serial numbers obtained as a result of currency bills being read by the cash processing terminals 200 configuring the cash processing terminal group and stores the serial numbers. According to this configuration, the serial numbers read by the cash processing terminals 200 are centrally managed, so it becomes possible to easily search and analyze the serial numbers.

Furthermore, the serial numbers are managed by the information processing device 100, which is different from the accounting system 600 with which the bank strictly manages data. For that reason, compared to a case where the serial numbers are managed by the accounting system 600, access restrictions taking into account security and/or communication volume are eased. Consequently, it becomes possible to easily access the information processing device 100 in order to search and/or analyze the serial numbers.

The information processing device 100 may be disposed as an independent device such as shown in FIG. 2, but it may also be integrated with another device. For example, the information processing device 100 may be disposed between the cash processing terminal group in the local network and the backbone network 500 in a state in which it is integrated with at least either one of the receipts-and-disbursements terminal 300C and the currency bill sorter terminal 300D.

Furthermore, the number of the cash processing terminals 200 is not particularly limited. Furthermore, in the example shown in FIG. 2, the ATM 200A, the teller cash recycler 200B, the receipts-and-disbursements cash counting machine 200C, and the currency bill sorter 200D are shown as examples of the cash processing terminals 200, but the types of the cash processing terminals 200 are also not particularly limited. Consequently, the cash processing terminals 200 configuring the cash processing terminal group may include at least any of the ATM 200A, the teller cash recycler 200B, the receipts-and-disbursements cash counting machine 200C, and the currency bill sorter 200D.

The configuration of the information processing system 10 pertaining to the embodiment of the present invention has been described above. Next, an example functional configuration of the cash processing terminal 200 pertaining to the embodiment of the present invention will be described.

[Description of Configurations]

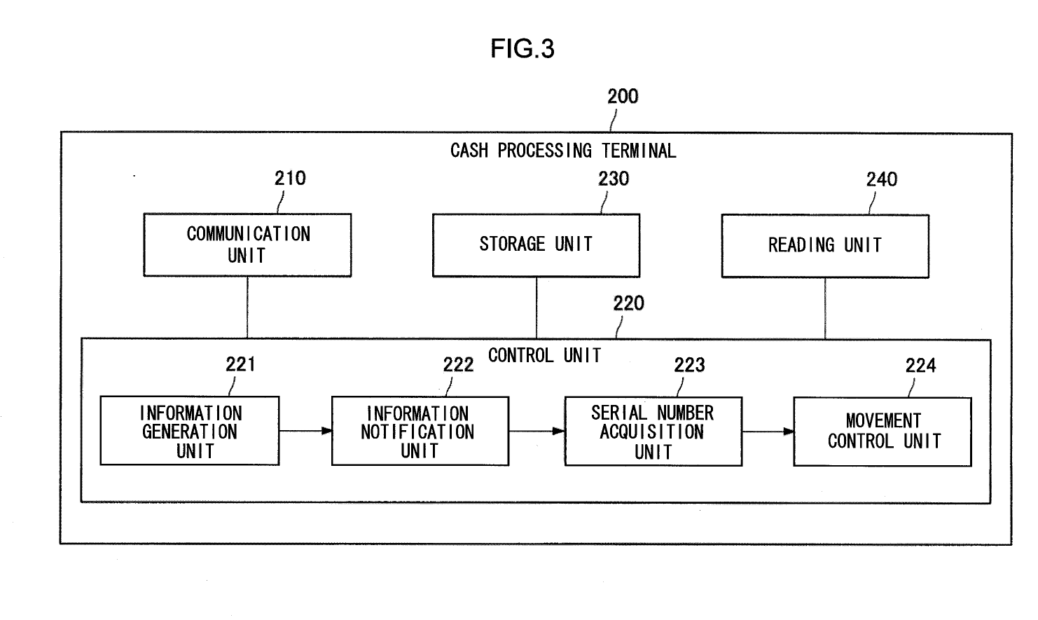

FIG. 3 is drawing showing an example functional configuration of the cash processing terminal 200 pertaining to the embodiment of the present invention. As shown in FIG. 3, the cash processing terminal 200 pertaining to the embodiment of the present invention is equipped with a communication unit 210, a control unit 220, a storage unit 230, and a reading unit 240.

The communication unit 210 has the function of communicating with other devices in accordance with control by the control unit 220. The control unit 220 has the function of controlling the entire operation of the cash processing terminal 200. The storage unit 230 can store data and a program for causing the control unit 220 to operate. Furthermore, the storage unit 230 can also temporarily store various types of data that become necessary in the process of the operation of the control unit 220. The reading unit 240 has the function of reading currency bills handled in transactions.

In the example shown in FIG. 3, the communication unit 210, the storage unit 230, and the reading unit 240 exist inside the cash processing terminal 200, but the communication unit 210, the storage unit 230, and the reading unit 240 may also be disposed outside the cash processing terminal 200. Furthermore, the control unit 220 is equipped with an information generation unit 221, an information notification unit 222, a serial number acquisition unit 223, and a movement control unit 224. The details of each of these functional units with which the control unit 220 is equipped will be described below.

The information generation unit 221 has the function of generating data (hereinafter also called “currency bill data”) relating to currency bills handled in transactions in the cash processing terminal 200. Here, the currency bill data include at least the serial numbers of the currency bills, but the currency bill data may also include transaction information, recognition results, and other information. For example, the information generation unit 221 can recognize the serial numbers from the reading data read by the reading unit 240. Furthermore, in a case where the information generation unit 221 cannot normally recognize the serial numbers from the reading data, it may also use, instead of the serial numbers, data of the serial number part of the reading data of the currency bills.

For example, the information generation unit 221 can also recognize recognition results from the reading data read by the reading unit 240. Furthermore, the information generation unit 221 can also acquire transaction information and other information from a predetermined place.

The information notification unit 222 has the function of giving notification to the information processing device 100 of the currency bill data generated by the information generation unit 221. Furthermore, the information notification unit 222 has the function of giving notification to the accounting system 600 of the currency bill data generated by the information generation unit 221. In a case where the accounting system 600 is given notification of the currency bill data, the currency bill data is sent by the communication unit 210 to the accounting system 600 via the backbone network 500.

In a case where it has been determined that a serial number of a currency bill is a duplicate, the serial number acquisition unit 223 acquires that serial number from the information processing device 100. For example, in a case where the serial number acquisition unit 223 has been given notification from the information processing device 100 of a serial number determined to be duplicate, the serial number acquisition unit 223 can acquire that serial number. For example, in a case where a counterfeit bill has been read, it is conceivable that the serial number of that counterfeit bill will be a duplicate of the serial number of a genuine currency bill. It does not matter who has detected the counterfeit bill.

The movement control unit 224 performs control so that the currency bill bearing the serial number acquired by the serial number acquisition unit 223 is moved to a predetermined location. As for the conveyance path of the currency bill, the currency bill bearing that serial number is moved to the predetermined location in accordance with control by the movement control unit 224. The predetermined location is not particularly limited and may, for example, be either a reject vault (a reject vault for currency bills) or a designated storage vault for currency bills.

Because the counterfeit bill is moved to the predetermined location in this way, the counterfeit bill can be isolated. Furthermore, transactions by the cash processing terminal 200 may also be stopped as the currency bill is moved to the predetermined location. Here, a case is supposed where the cash processing terminal 200 that gave notification of the serial number to the information processing device 100 and the cash processing terminal 200 that acquires the serial number from the information processing device 100 are the same, but they may also be different.

An example functional configuration of the cash processing terminal 200 pertaining to the embodiment of the present invention has been described above. Next, an example functional configuration of the information processing device 100 pertaining to the embodiment of the present invention will be described.

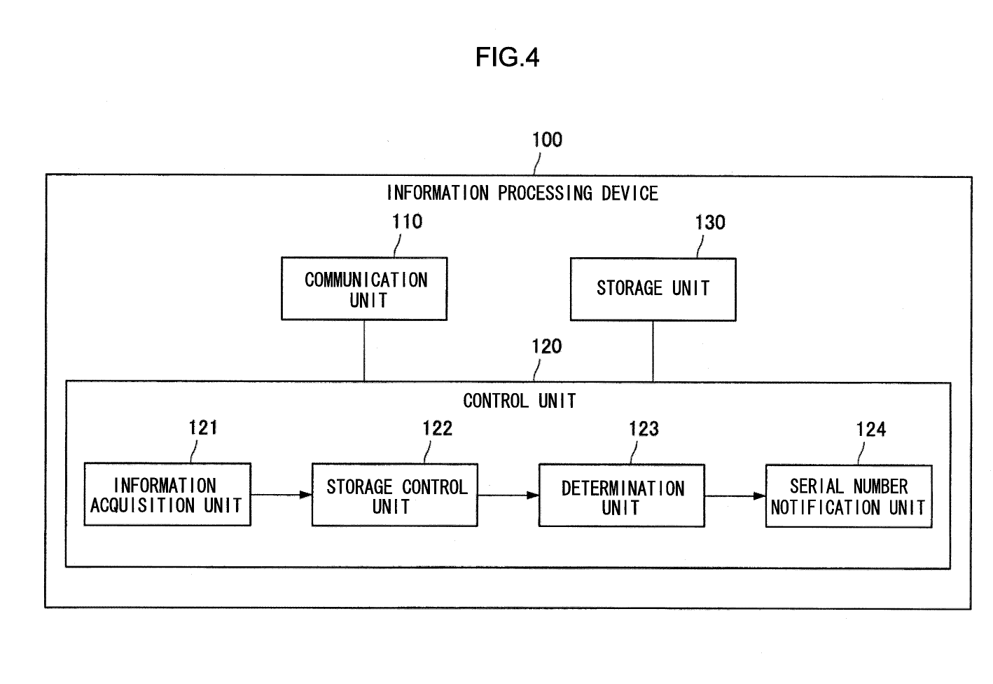

FIG. 4 is a drawing showing an example functional configuration of the information processing device 100 pertaining to the embodiment of the present invention. As shown in FIG. 4, the information processing device 100 pertaining to the embodiment of the present invention is equipped with a communication unit 110, a control unit 120, and a storage unit 130.

The communication unit 110 has the function of communicating with other devices in accordance with control by the control unit 120. The control unit 120 has the function of controlling the entire operation of the information processing device 100. The storage unit 130 can store data and a program for causing the control unit 120 to operate. Furthermore, the storage unit 130 can also temporarily store various types of data that become necessary in the process of the operation of the control unit 120.

In the example shown in FIG. 4, the communication unit 110 and the storage unit 130 exist inside the information processing device 100, but the communication unit 110 and the storage unit 130 may also be disposed outside the information processing device 100. Furthermore, the control unit 120 is equipped with an information acquisition unit 121, a storage control unit 122, a determination unit 123, and a serial number notification unit 124. The details of each of these functional units with which the control unit 120 is equipped will be described below.

The information acquisition unit 121 has the function of acquiring, in the local network, the currency bill data generated by the cash processing terminals 200 configuring the cash processing terminal group (that is, the information acquisition unit 121 has the function of acquiring the currency bill data via the local network). For example, the information acquisition unit 121 acquires, in the local network, the currency bill data of which notification has been given by the information notification units 222.

The storage control unit 122 stores the currency bill data acquired by the information acquisition unit 121 in the storage unit 130. The currency bill data include at least serial numbers. Furthermore, in a case where the currency bill data acquired by the information acquisition unit 121 include information in addition to serial numbers (e.g., transaction information, recognition results, and other information), the storage control unit 122 stores those pieces of information as histories in association with those serial numbers in the storage unit 130.

Because information other than the serial numbers is also added to the histories in this way, information in addition to the serial numbers can also be utilized for search and analysis. Moreover, the transaction information may also have a format shared in common by the plural cash processing terminals 200 configuring the cash processing terminal group. In a case where transaction information having a format shared in common by the plural cash processing terminals 200 is utilized, it becomes easier to utilize the transaction information for search and analysis compared to a case where transaction information having formats that differ according to the cash processing terminals 200 is utilized.

In a case where a serial number obtained as a result of a currency bill being read by any of the cash processing terminals 200 configuring the cash processing terminal group has been acquired, the determination unit 123 determines whether or not that serial number matches a serial number stored in the storage unit 130. The serial number is acquired, for example, by the communication unit 110 from the cash processing terminal 200 that read the currency bill. In a case where it has been determined by the determination unit 123 that the serial numbers match, the control of the storage of the serial number in the storage unit 130 by the storage control unit 122 may be omitted. This is because in a case where it has been determined that the serial numbers match, the suspicion that either one of the currency bills bearing that serial number is a counterfeit bill is high.

Furthermore, the determination unit 123 may also perform additional determinations after it has determined whether or not the serial numbers match. Those other determinations will be described later.

In a case where it has been determined by the determination unit 123 that the serial numbers match, the serial number notification unit 124 gives notification of that serial number to any of the cash processing terminals 200 configuring the cash processing terminal group or a cash processing terminal 200 in a local network (hereinafter also called a “second local network”) differing from the local network (hereinafter also called a “first local network”). The serial number notification unit 124 may give notification of the serial number acquired from the storage unit 130 to all or some of the cash processing terminals in the cash processing terminal group in the first local network and the cash processing terminal group in the second local network.

For example, a case is conceivable where the second local network exists in a bank branch different from the bank branch in which the first local network exists and where the second local network is connected to the backbone network 500. Furthermore, for example, the serial number notification unit 124 may also give notification of the serial number to a cash processing terminal selected from among the cash processing terminal group in the first local network and the cash processing terminal group in the second local network. The selection of the cash processing terminal is performed by the serial number notification unit 124 on the basis of an operation performed on an input unit 150 by an operator, for example.

The serial number notification unit 124 may also give notification of the serial number to a cash processing terminal selected in accordance with the results of the other determinations by the determination unit 123.

An example functional configuration of the information processing device 100 pertaining to the embodiment of the present invention has been described above. Next, an example configuration of accumulation data accumulated in the information processing device 100 pertaining to the embodiment of the present invention will be described.

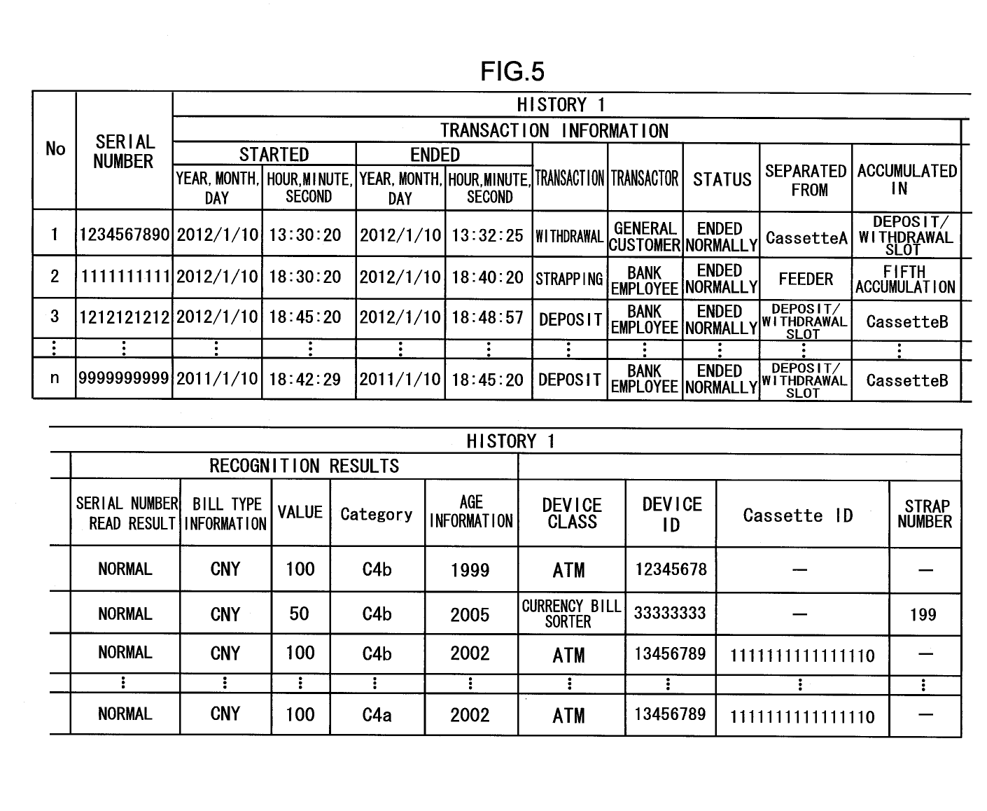

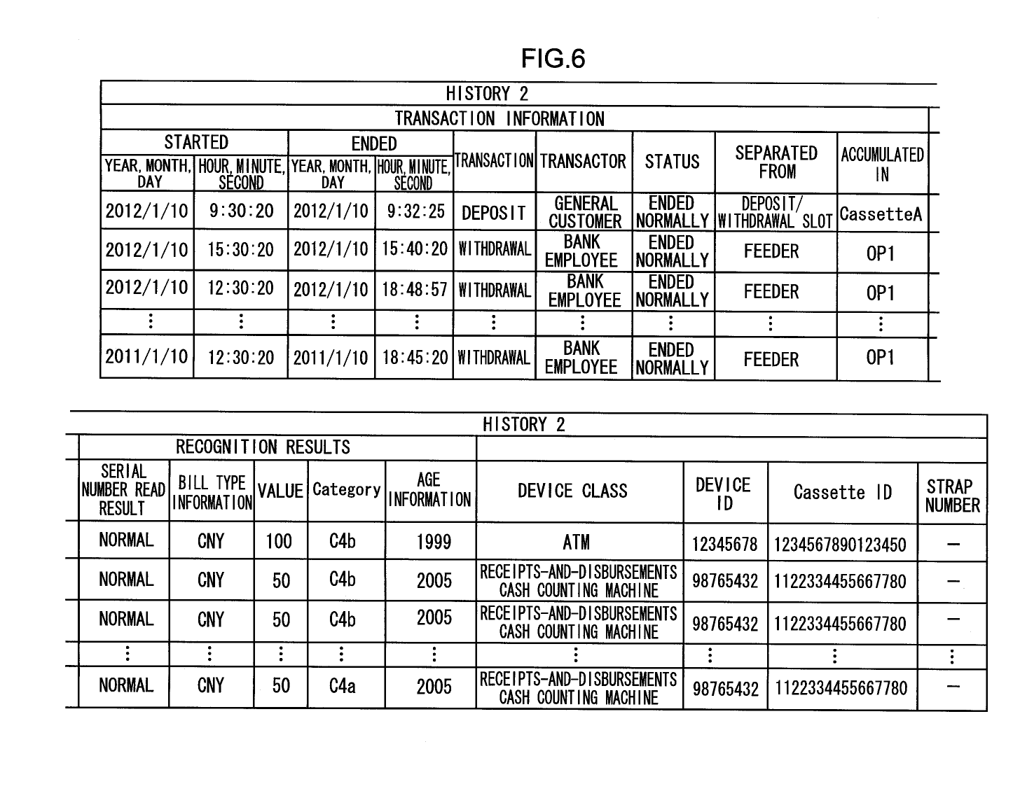

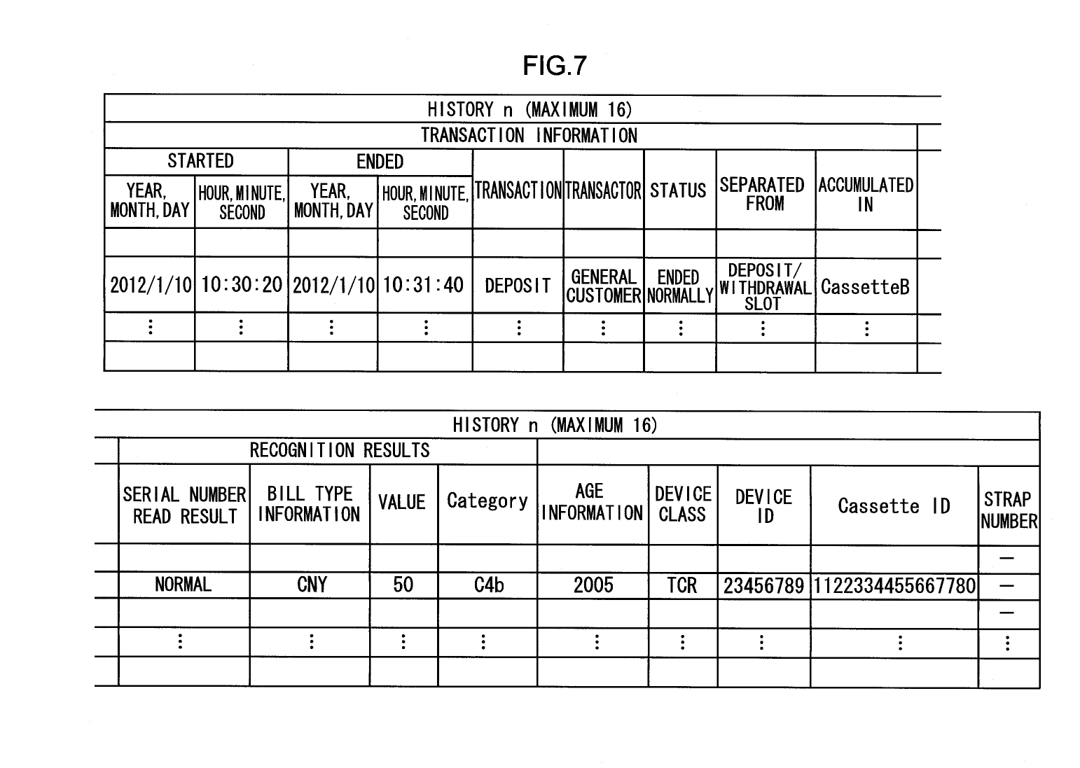

FIG. 5 to FIG. 7 are drawings showing an example configuration of the accumulation data accumulated in the information processing device 100 pertaining to the embodiment of the present invention. As shown in FIG. 5 to FIG. 7, the accumulation data are configured in such a way that histories 1 to n (e.g., n≦16) are associated with each of the serial numbers. That is, when the information processing device 100 acquires the serial numbers and the histories from the cash processing terminals 200, it stores those histories in association with those serial numbers. Each history includes, for example, “transaction information”, “recognition results”, and “other information”.

The “transaction information” includes “started”, “ended”, “transaction”, “transactor”, “status”, “separated from”, and “accumulated in”. “Started” indicates the day and time when the transaction by the cash processing terminal 200 started, and “ended” indicates the day and time when the transaction by the cash processing terminal 200 ended. “Transaction” is information indicating the type of transaction performed by the cash processing terminal 200, and examples of transactions include deposits, withdrawals, strapping, and counting.

“Transactor” is information indicating the person who performed the transaction. For example, in a case where a deposit or withdrawal transaction is performed by the ATM 200A and/or the teller cash recycler 200B, the customer becomes the transactor, and in a case where a counting transaction is performed by the teller cash recycler 200B, a bank employee becomes the transactor, and in a case where a transaction by the receipts-and-disbursements cash counting machine 200C or the currency bill sorter 200D is performed, a bank employee becomes the transactor.

“Status” is information indicating whether or not the transaction ended normally. Examples of statuses included “ended normally” and “ended in an error”. “Accumulated in” is information indicating places where the currency bills are stored inside the cash processing terminal 200. Examples of accumulation destinations include a cassette, a deposit/withdrawal slot, a temporary retainer, an accumulation vault, and a reject vault. In particular, the reject vault is an accumulation destination where, in a case where an abnormal currency bill has been detected, that currency bill is stored.

“Recognition results” includes “serial number read result”, “bill type information”, “value”, “category”, and “age information”. “Serial number read result” indicates whether or not the serial number was able to be normally read. In a case where the serial number cannot be normally recognized, data of the serial number part of the reading data of the currency bill may also be accumulated instead of the serial number. “Bill type information” is information indicating the area (e.g., country) that issued the currency bill. Examples of bill type information include the monetary unit of the U.S. (=the U.S. dollar), the monetary unit of China (=the Chinese yuan), and the monetary unit of Japan (=the Japanese yen). “Value” is information indicating the value of the currency bill.

“Category” is information indicating categories of currency bills and is expressed, for example, by C1, C2, C3, C4a, and C4b. C1 is a category to which bills other than currency bills belong, C2 is a category to which bills suspected of being counterfeit bills belong, and C3 is a category to which bills whose potential to be counterfeit bills is high belong. Furthermore, C4a is a category to which bills that are fit bills belong, and C4b is a category to which bills that are unfit bills belong. “Age information” is information indicating the age of the currency bills.

“Other information” includes “device class”, “device ID”, “cassette ID”, and “strap number”. “Device class” is information indicating the class of the cash processing terminal 200 that performed the transaction. For example, “device class” may be information indicating any of the ATM, the teller cash recycler, the receipts-and-disbursements cash counting machine, and the currency bill sorter. “Device ID” corresponds to the ID for identifying the cash processing terminal 200 that performed the transaction. “Cassette ID” corresponds to the ID for identifying the cassette C in which the currency bill is being stored. “Strap number” corresponds to the strap number printed on the currency bill bundle that was strapped by the currency bill sorter 200D.

An example configuration of the accumulation data accumulated in the information processing device 100 pertaining to the embodiment of the present invention has been described above. Next, a flow of operations in a case where the information processing system 100 pertaining to the embodiment of the present invention is operated will be described.

[Description of Operations]

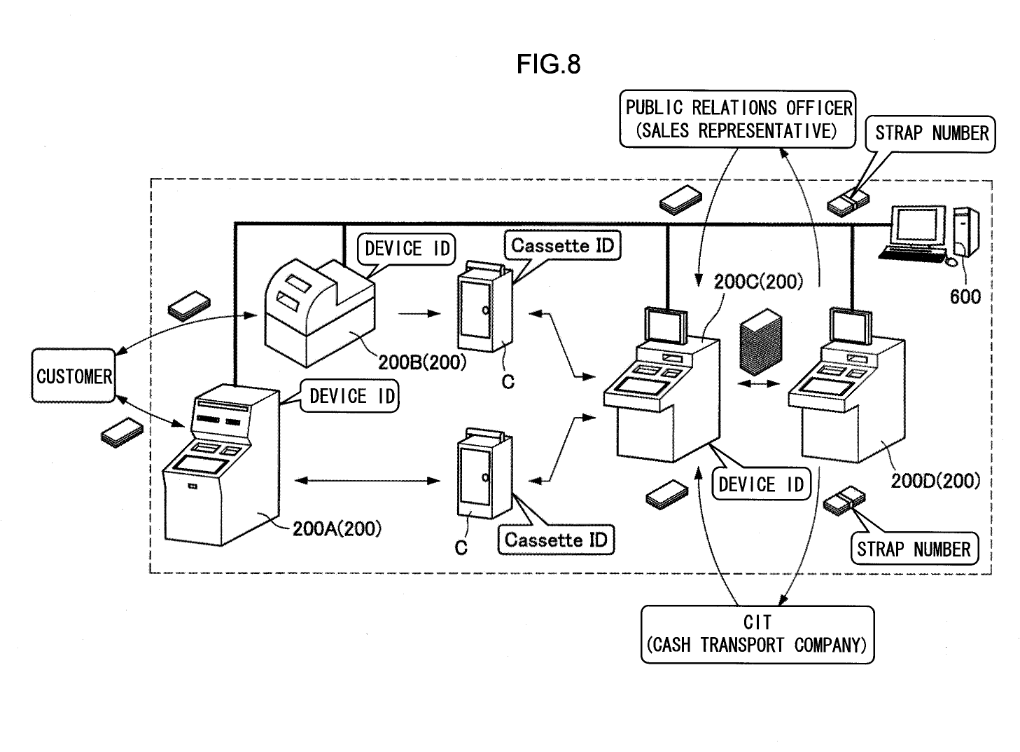

FIG. 8 is a drawing showing an example operation of the information processing system pertaining to the embodiment of the present invention. As shown in FIG. 8, first, a customer deposits or withdraws currency bills using the ATM 200A and/or the teller cash recycler 200B. When settling cash, such as when operation ends, an employee of the financial institution removes the cassettes C from the ATM 200A and the teller cash recycler 200B and loads the removed cassettes C into the receipts-and-disbursements cash counting machine 200C.

Next, the employee of the financial institution uses the receipts-and-disbursements cash counting machine 200C to count the currency bills to establish the balance of currency bills on hand. The employee of the financial institution deposits the currency bills dispensed by the receipts-and-disbursements cash counting machine 200C into the currency bill sorter 200D.

The employee of the financial institution uses the currency bill sorter 200D to sort the currency bills by denomination and sort the currency bills into unfit bills and fit bills. Here, unfit bills correspond to currency bills that have damage or stains and are not to be allowed to circulate on the market. Fit bills correspond to currency bills that are not unfit bills and pose no problem if they are allowed to recirculate on the market. The employee of the financial institution uses the currency bill sorter 200D to sort the currency bills and strap every predetermined number of the bills (e.g., 100 bills) into bill bundles.

The strapped bill bundles have the potential to be stored in a vault in the bank and have the potential to be transported to a cash center or another branch. There is also the potential for a public relations officer (or a sales representative) to carry the bill bundles to a customer outside the branch for the purpose of business operations. Depending on the operational policy of that financial institution, there are also cases where the currency bills are stored in a vault in the bank or are transported to a cash center or another branch while remaining stored in the cassette C.

A public relations officer or a service provider who transports cash to financial institutions (a cash transport company=Cash In Transit (CIT)) deposits currency bills into the receipts-and-disbursements cash counting machine 200C and has the receipts-and-disbursements cash counting machine 200C count the currency bills to establish the balance on hand of the currency bills that have been brought in. Furthermore, the public relations officer or the service provider who transports cash to financial institutions puts the currency bills whose denominations and numbers have been established into the cassette C in order to restock the ATM 200A and/or the teller cash recycler 200B with cash. An employee of the financial institution loads the cassette C into which the currency bills have been put in this way into the ATM 200A and/or the teller cash recycler 200B to start transactions with customers.

In the workflow described above, each time currency bills are counted by each of the cash processing terminals 200, the serial numbers of the currency bills are read by the cash processing terminals 200 and notification of the serial numbers is given to the information processing device 100 as the currency bill data. The currency bill data of which notification has been given are edited into the format in which the serial numbers and the histories have been associated with one another as shown in FIG. 5 to FIG. 7 and are accumulated in the storage unit 130 of the information processing device 100. Because of this, the information processing device 100 can manage the histories of the currency bills (e.g., how the current bills had been handled in the bank).

A flow of operations in a case where the information processing system 10 pertaining to the embodiment of the present invention is operated has been described above. Next, an example of a flow of operations of the information processing device 100 pertaining to the embodiment of the present invention will be described.

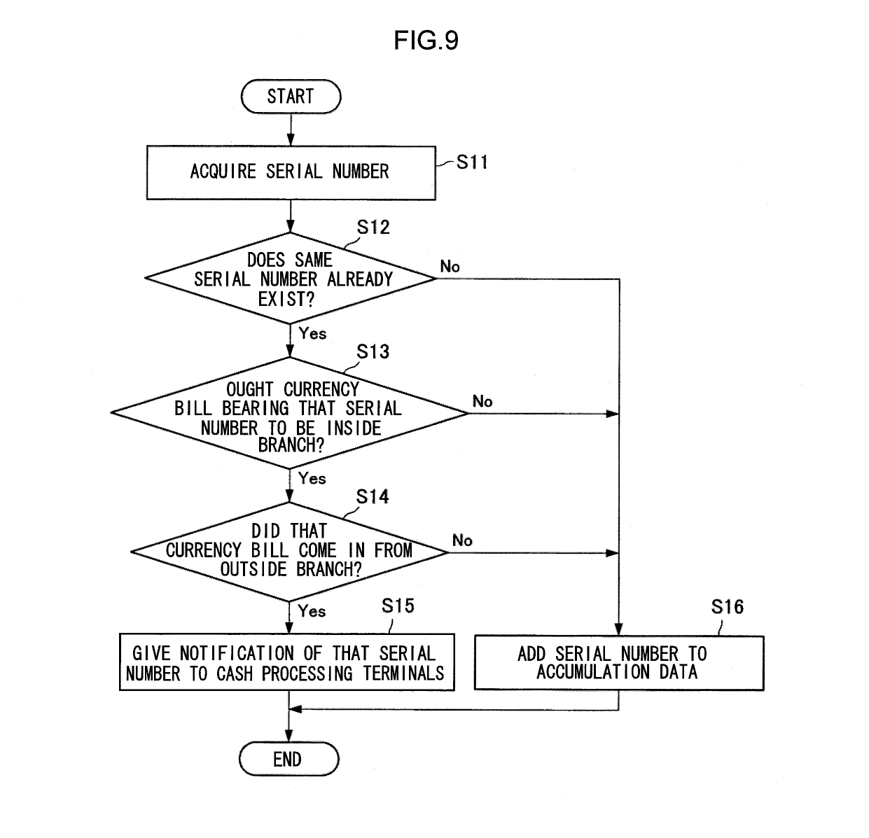

FIG. 9 is a drawing showing an example of a flow of operations of the information processing device 100 pertaining to the embodiment of the present invention. The example of the flow of operations shown in FIG. 9 is merely an example of a flow of operations of the information processing device 100, so it goes without saying that the operations of the information processing device 100 are not limited to the example shown in FIG. 9. Furthermore, a case is supposed where the operations shown in FIG. 9 are performed when the information processing device 100 acquires a serial number of a currency bill from the cash processing terminals 200 and registers the serial number in the storage unit 130, but the operations shown in FIG. 9 are not limited to this example.

As shown in FIG. 9, the information acquisition unit 121 acquires a serial number from a cash processing terminal 200 configuring the cash processing terminal group (step S11). Next, the determination unit 123 determines whether or not a serial number identical to the serial number acquired by the information acquisition unit 121 already exists among the serial numbers in the accumulation data (step S12). As was described above, the accumulation data are configured by combinations of serial numbers and histories and are stored by the storage unit 130.

In a case where the determination unit 123 has determined that the serial number does not yet exist in the accumulation data (“No” in step S12), the information processing device 100 proceeds to step S16 because it is likely that the currency bill is not suspected of being a counterfeit bill. On the other hand, in a case where the determination unit 123 has determined that the serial number already exists in the accumulation data (“Yes” in step S12), the determination unit 123 may also perform other additional determinations. That is, the determination unit 123 may also determine whether or not the currency bill bearing that serial number ought to be inside the branch (step S13). Furthermore, the determination unit 123 may also determine whether or not the currency bill bearing that serial number came in from outside the branch (step S14).

For example, what qualifies as a case where the currency bill ought to be outside the branch is a case where a transaction (e.g., a “withdrawal” or a “return”) accompanied by the currency bill being taken outside the cash processing terminals 200 was set in the history at the time of the previous transaction involving the currency bill. On the other hand, what qualifies as a case where the currency bill ought to be inside the branch is a case where a transaction (e.g., a “deposit”) not accompanied by the currency bill being taken outside the cash processing terminals 200 was set in the history at the time of the previous transaction involving the currency bill.

Furthermore, for example, what qualifies as a case where the currency bill has come in from outside the branch is a case where, when the current transaction has been acquired together with the serial number by the information acquisition unit 121, a transaction (e.g., a “deposit”) accompanied by the currency bill being inserted into the cash processing terminals 200 is set in that transaction. On the other hand, what qualifies as a case where the currency bill was inside the branch is a case where, when the current transaction has been acquired together with the serial number by the information acquisition unit 121, a transaction (e.g., a “withdrawal” or a “return”) not accompanied by the currency bill being inserted into the cash processing terminals 200 is set in that transaction.

In a case where the determination unit 123 has determined that the currency bill bearing that serial number ought to be outside the branch (“No” in step S13), the information processing device 100 proceeds to step S16 because it is likely that the currency bill is not suspected of being a counterfeit bill. On the other hand, in a case where the determination unit 123 has determined that the currency bill bearing that serial number ought to be inside the branch (“Yes” in step S13), the determination unit 123 determines whether or not the currency bill bearing that serial number came in from outside the branch (step S14).

In a case where the determination unit 123 has determined that the currency bill bearing that serial number came in from outside the branch (“No” in step S14), the serial number notification unit 124 gives notification of that serial number to the cash processing terminals 200 because it is likely that the currency bill is suspected of being a counterfeit bill (step S15), and then the information processing device 100 ends operations. On the other hand, in a case where the determination unit 123 has determined that the currency bill bearing that serial number was inside the branch (“Yes” in step S14), the information processing device 100 proceeds to step S16 because it is likely that the currency bill is not suspected of being a counterfeit bill.

In step S16, the storage control unit 122 adds the serial number acquired by the information acquisition unit 121 to the accumulation data. At this time, in a case where currency bill recognition results were acquired together with the serial number by the information acquisition unit 121, the storage control unit 122 adds those recognition results to the history. Here, the addition of the serial number to the accumulation data is performed after it has been determined that the currency bill bearing that serial number is not suspected of being a counterfeit bill, but it may also be performed regardless of whether or not the currency bill is suspected of being a counterfeit bill.

The cash processing terminals 200 to which notification of the serial number has been given can register that serial number. Furthermore, in a case where the currency bill bearing that serial number has been detected, the cash processing terminals 200 can move that currency bill to the predetermined location. Because the counterfeit bill is moved to the predetermined location by the cash processing terminals 200, the counterfeit bill can be isolated.

An example of a flow of operations of the information processing device 100 pertaining to the embodiment of the present invention has been described above. Next, another example of a flow of operations of the information processing device 100 pertaining to the embodiment of the present invention will be described.

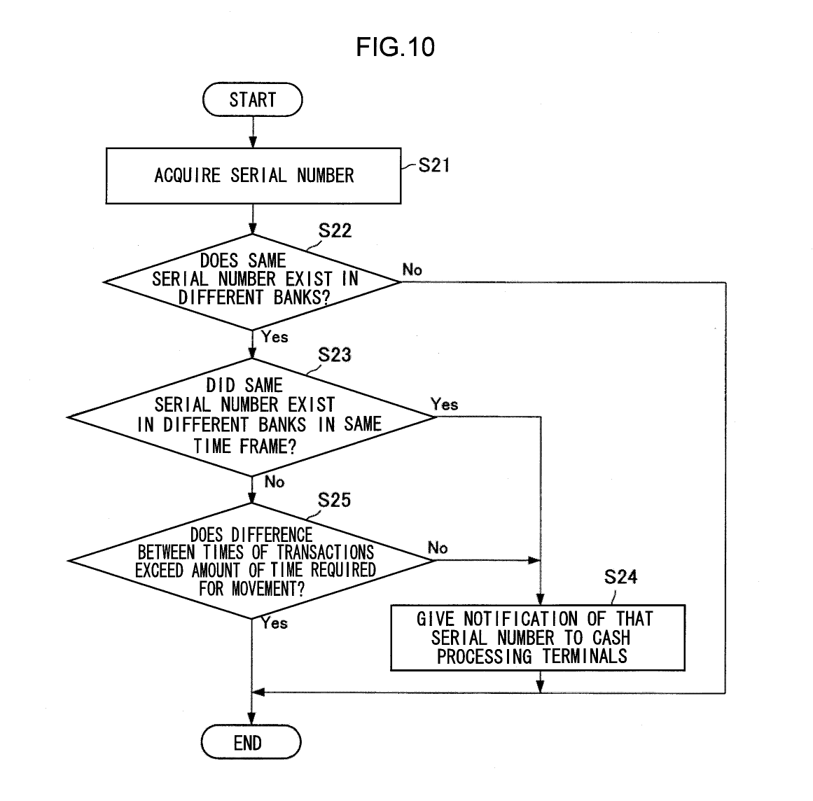

FIG. 10 is a drawing showing another example of a flow of operations of the information processing device 100 pertaining to the embodiment of the present invention. The example of the flow of operations shown in FIG. 10 is merely an example of a flow of operations of the information processing device 100, so it goes without saying that the operations of the information processing device 100 are not limited to the example shown in FIG. 10.

Furthermore, in the example shown in FIG. 10, a case is supposed where the information processing device 100 acquires a serial number of a currency bill transacted by another information processing device and checks its own stored histories on the basis of that serial number. Here, it is supposed that the information processing device 100 is an information processing device disposed between the cash processing terminal group in the first local network and the backbone network 500. Furthermore, it is supposed that the other information processing device is an information processing device disposed between the cash processing terminal group in the second local network and the backbone network 500. The first local network and the second local network exist in different banks

As shown in FIG. 10, the information acquisition unit 121 acquires a serial number from the other information processing device (step S21). Next, the determination unit 123 determines whether or not the same serial number exists in the different banks (step S22). Specifically, the determination unit 123 can determine whether or not a serial number identical to the serial number acquired by the information acquisition unit 121 exists among the serial numbers of its own stored accumulation data to thereby determine whether or not the same serial number exists in the different banks

In a case where the determination unit 123 has determined that the same serial number did not exist in the different banks in the same time frame (“Yes” in step S23), the information processing device 100 proceeds to step S24 because it is likely that the currency bill is suspected of being a counterfeit bill. On the other hand, in a case where the determination unit 123 has determined that the same serial number existed in the different banks in the same time frame (“No” in step S23), the determination unit 123 determines whether or not the difference between the times of the transactions involving that currency bill exceeds an amount of time required for movement (step S25).

Here, in a case where the determination unit 123 has determined that the difference between the times of the transactions involving that currency bill does not exceed the amount of time required for movement (“No” in step S25), the serial number notification unit 124 gives notification of that serial number to the cash processing terminals 200 because it is likely that the currency bill is suspected of being a counterfeit bill (step S24), and then the information processing device 100 ends operations. On the other hand, in a case where the determination unit 123 has determined that the difference between the times of the transactions involving that currency bill exceeds the amount of time required for movement (“Yes” in step S25), the information processing device 100 ends operations because it is likely that the currency bill is not suspected of being a counterfeit bill.

The cash processing terminals 200 to which notification of the serial number has been given can register that serial number. Furthermore, in a case where the cash processing terminals 200 have detected the currency bill bearing that serial number, the cash processing terminals 200 can move that currency bill to the predetermined location. Because the counterfeit bill is moved to the predetermined location by the cash processing terminals 200, the counterfeit bill can be isolated.

Another example of a flow of operations of the information processing device 100 pertaining to the embodiment of the present invention has been described above.

[Description of Advantageous Effects]

As described above, according to the embodiment of the present invention, the information processing system 10 mainly differs from the typical information processing system 10′ in that the information processing system 10 is equipped with the information processing device 100. In particular, the information processing device 100 is disposed between the cash processing terminal group in the local network and the backbone network 500.

The information processing device 100 acquires, in the local network, serial numbers obtained as a result of currency bills being read by the cash processing terminals 200 configuring the cash processing terminal group and stores the serial numbers. According to this configuration, the serial numbers read by the cash processing terminals 200 are centrally managed, so it becomes possible to easily search and analyze the serial numbers.

Furthermore, notification of the serial number of a counterfeit bill is automatically given to the cash processing terminals, so there is no longer the need for an operator (e.g., a bank employee or a maintenance worker) to manually enter a registration of the serial number of the counterfeit bill into each cash processing terminal, and the working time of the operator can be reduced. Furthermore, it becomes possible to reduce entry errors when entering the serial number of a counterfeit bill. Furthermore, the cash processing terminals to which notification of a serial number has been given can, in a case where the currency bill bearing that serial number has been detected, perform control so that the currency bill is moved to the predetermined location.

[Description of Example Modifications]

A preferred embodiment of the present invention has been described in detail above with reference to the attached drawings, but the present invention is not limited to this example. It will be apparent that a person having ordinary knowledge in the technical field to which the present invention belongs can arrive at a variety of example alterations and example modifications within the category of technical thought described in the claims, and these also will be understood as belonging to the technical scope of the present invention.

Each of the blocks configuring the control unit 120 is configured from a central processing unit (CPU) and a random access memory (RAM), for example, and their functions can be realized as a result of a program stored by the storage unit 130 being expanded and executed in the RAM by the CPU. Each of the blocks configuring the control unit 120 may also be configured by dedicated hardware components and may also be configured by a combination of plural hardware components.

Each of the blocks configuring the control unit 220 is configured from a central processing unit (CPU) and a random access memory (RAM), for example, and their functions can be realized as a result of a program stored by the storage unit 230 being expanded and executed in the RAM by the CPU. Each of the blocks configuring the control unit 220 may also be configured by dedicated hardware components or may also be configured by a combination of plural hardware components.

In this specification, the steps appearing in the flowcharts include processes performed in a time series in accordance with the described order and also include processes executed in parallel or discretely even if they are not invariably performed in a time series. Furthermore, it goes without saying that even steps performed in a time series can also have their order appropriately changed depending on the case.

The disclosure of Japanese Patent Application No. 2012-154393 is incorporated in its entirety by reference herein. All publications, patent applications, and technical standards mentioned in this specification are incorporated by reference herein to the same extent as if each publication, patent application, or technical standard was specifically and individually indicated to be incorporated by reference.

1. An information processing device disposed between a cash processing terminal group in a local network and an outside network existing outside the local network, the information processing device comprising:
an information acquisition unit that acquires, in the local network, a serial number obtained as a result of a currency bill being read by a cash processing terminal configuring the cash processing terminal group;
a storage control unit that stores the serial number in a storage unit; and
a determination unit which, in a case in which a serial number obtained as a result of a currency bill being read by any cash processing terminal configuring the cash processing terminal group has been acquired, determines whether or not that serial number matches the serial number stored in the storage unit.

2. The information processing device according to claim 1, further comprising a serial number notification unit which, in a case in which it has been determined by the determination unit that the serial numbers match, gives notification of the serial number to any cash processing terminal configuring the cash processing terminal group or to a cash processing terminal in a local network that is different from the local network.

3. The information processing device according to claim 2, wherein the serial number notification unit gives notification to a cash processing terminal selected from among any cash processing terminal configuring the cash processing terminal group and a cash processing terminal in a local network that is different from the local network.

4. A cash processing terminal configuring a cash processing terminal group in a local network, the cash processing terminal comprising:
a serial number acquisition unit which, in a case in which it has been determined that a serial number of a currency bill is a duplicate, acquires that serial number from an information processing device disposed between the cash processing terminal and an outside network existing outside the local network; and
a movement control unit that performs control so that the currency bill bearing the serial number acquired by the serial number acquisition unit is moved to a predetermined location.

5. The cash processing terminal according to claim 4, wherein the predetermined location is either a reject vault for currency bills or a designated storage vault for currency bills.

6. An information processing system, comprising a cash processing terminal configuring a cash processing terminal group in a local network and an information processing device disposed between the cash processing terminal and an outside network existing outside the local network, wherein:
the cash processing terminal comprises an information notification unit that gives notification of a serial number obtained by reading a currency bill; and
the information processing device comprises:
an information acquisition unit that acquires, in the local network, the serial number regarding which notification has been given by the cash processing terminal;
a storage control unit that stores the serial number in a storage unit; and
a determination unit which, in a case in which a serial number obtained as a result of a currency bill being read by any cash processing terminal configuring the cash processing terminal group has been acquired, determines whether or not that serial number matches the serial number stored in the storage unit.

7. The information processing system according to claim 6, wherein the information processing device further comprises a serial number notification unit which, in a case in which it has been determined by the determination unit that the serial numbers match, gives notification of the serial number to any cash processing terminal configuring the cash processing terminal group or to a cash processing terminal in a local network that is different from the local network.

8. The information processing system according to claim 7, wherein the serial number notification unit gives notification to a cash processing terminal selected from among any cash processing terminal configuring the cash processing terminal group and a cash processing terminal in a local network that is different from the local network.
